(19) United States
(12) Patent Application Publication
(10) Pub. No.: US 2002/0159484 A1
(43) Pub. Date: Oct. 31, 2002

(54) Coding scheme using a control code map for signal transmission in optical communications networks

(76) Inventors: Murat Azizoglu, North Billerica, MA (US); Danny Hin-Kwok Tsang, Acton, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/794,727

(22) Filed: Feb. 27, 2001

Related U.S. Application Data
(60) Provisional application No. 60/251,341, filed on Dec. 5, 2000.

(51) Int. Cl. H04J 3/12

(52) U.S. Cl. 370/522; 370/392

(57) ABSTRACT

A coding scheme is provided for transporting information over an optical communications link to a network. Information containing data and control characters is encoded after segmenting the information into multi-word information groups and determining whether each of the information groups includes control characters. If the information group does not include any control characters, an encoded information stream including a set data indicator and data words is generated. If the information group includes one or more control characters, the control characters are encoded to control codes and a control code map is generated for representing placement positions of the control characters within the information group. Then, an encoded information stream is generated to include the control code map combined with one of the control codes as well as the remaining control codes and/or data words. Accordingly, the necessary bandwidth for transporting the information is reduced after the encoding is completed without sacrificing any control information.

### CROSS REFERENCE TO RELATED APPLICATIONS

This application claims priority under 35 U.S.C. §119(e) to provisional patent application serial No. 60/251,341, filed Dec. 5, 2000, the disclosure of which is hereby incorporated by reference.

### STATEMENT REGARDING FEDERALLY SPONSORED RESEARCH OR DEVELOPMENT

N/A

### BACKGROUND OF THE INVENTION

The present invention relates to an efficient transport of encoded traffic in optical communications networks employing synchronous signaling techniques, such as networks employing Synchronous Optical Network (SONET) or Synchronous Digital Hierarchy (SDH) signaling formats.

A large number of wavelength-division multiplexed (WDM) point-to-point transmission systems and WDM networks presently exist. Many of these systems have been designed to support a fixed number of wavelengths and a predetermined data format. SONET is a common framing format for data transport in long-haul and metropolitan-area WDM carrier networks. The SONET frame provides a convenient standard mechanism to multiplex and transport circuit-switched traffic in high-speed backbones and support network functions. As a result of its beneficial characteristics, SONET framing is presently used in most WDM systems.

In contrast to SONET framing, many packet-switched local area networks (LANs) use framing defined in the long-established Ethernet standard. Unlike SONET, Ethernet and other LAN protocols rely on non-synchronous signaling techniques. Ethernet has become the dominant LAN technology such that virtually all data traffic originates and terminates as an Ethernet frame with an IP header. Ethernet has evolved to become a switched technology in which there are no protocol related distance limitations and the only distance limitation remaining is due to the physical layer. Furthermore, Ethernet supports a wide range of transmission rates ranging from 10 Megabits per second (Mbps) for Ethernet service, 100 Mbps for Fast Ethernet (FE) service, 1 Gigabit per second (Gbps) for Gigabit Ethernet (GbE) service, and up to 10 Gbps Dense WDM (DWDM) and possibly higher rates in the near future.

Ethernet typically connects at the LAN edge via a router to a variety of WAN technologies, such as SONET/SDH, ATM, and T1. Carriers and service providers have addressed the demands for Ethernet, FE, GbE, and DWDM with high performance L2/L3 switches, optical fiber infrastructure, long reach Ethernet interfaces, and optical switches. However, problems result in meeting these demands due to the scarcity and expense of WAN bandwidth, the need for additional customer premises equipment, and the installation and administration of unfamiliar WAN interfaces. It is desirable to combine WAN technologies, such as SONET/SDH, with Ethernet by more efficiently utilizing the SONET/SDH bandwidth to transparently offer end to end carrier class Ethernet service with diverse bit rates.

Because SONET and GbE have been separately optimized for transport and data networking, these signaling mechanisms have been treated in an isolated manner. For instance, a typical WDM network with OC-48 interfaces can accept only SONET-framed traffic at the OC-48 rate (2.488 Gbps). A mechanism is not presently available for efficiently and transparently accepting variable-sized packets transmitted at a non-SONET rate, such as the 1.25 Gbps rate of a GbE network. Even though a SONET framer may be used to translate a GbE signal into an OC-48 SONET signal, this approach would result in an inefficient utilization of the available bandwidth (only about 40% of the available bandwidth is used) at each wavelength transporting such traffic.

### SUMMARY OF THE INVENTION

In accordance with the present invention, methods and apparatus are provided for a coding scheme which efficiently and transparently transports information over an optical communications link to a network. Information containing data and control words is encoded after segmenting the information into multi-word information groups and determining whether each of the information groups includes control characters. If the information group does not include any control characters, an encoded information stream including a data indicator followed by the data words is generated. If the information group includes one or more control characters, the control characters are encoded to control codes and a control code map is generated for representing placement positions of the control words within the information group. Then, an encoded information stream is generated to include the control code map followed by one of the control codes and then the remaining control codes and/or data. Accordingly, the necessary bandwidth for transporting the information is reduced after the encoding is completed without sacrificing any control information so that the information is transparently and efficiently transported over the communications link.

After transporting the encoded information stream over a network, the information may be decoded back to its original form. If the data indicator is set, only data will follow and the data words are extracted from the encoded information stream. If the data indicator is not set, one or more control codes must follow. Therefore, the control code map is analyzed to determine the locations of the control codes within the encoded information stream. The control codes are decoded back to control characters and any remaining data words are extracted from the encoded information stream for generating the information group of control characters and data words.

The coding scheme is particularly suited for transporting GbE traffic over SONET/SDH based networks. For instance, the data carrying capacity for one or a combination of GbE signals may be reduced so that the available bandwidth provided by the SONET/SDH signal is efficiently utilized.

### BRIEF DESCRIPTION OF THE DRAWING

The invention will be more fully understood by reference to the following detailed description of the invention in conjunction with the drawings, of which:

FIG. 1 is a block diagram illustrating the interconnectivity between a switch and routers according to an embodiment of the present invention;

FIG. 2 illustrates a platform for a transmission network according to an embodiment of the present invention;

FIG. 3 is a block diagram illustrating the transmitting and receiving portions of a line interface of a communications node according to another embodiment of the present invention;

FIG. 4 illustrates a configuration of an encoded information stream according to an embodiment of the present invention;

FIG. 5 is a flowchart for an encoding algorithm according to an embodiment of the present invention; and

FIG. 6 is a flowchart for a decoding algorithm according to a embodiment of the present invention.

### DETAILED DESCRIPTION OF THE INVENTION

In accordance with the embodiments of the present invention, an efficient transport of packet traffic in optical communications networks is provided. Specifically, to transport traffic including basic MAC frames, MAC Control frames, and control words across MAN/WAN, a transparent physical layer connectivity is provided for carrying the traffic via an efficiently sized SONET/SDH signal. The embodiments of the present invention may transparently transport Fibre Channel (FC), Enterprise Systems (ESCON), Fiber Connector (FICON), GbE and other data formats that have been encoded using block line codes into SONET/SDH paths. It should be appreciated that the term “control character” will be used throughout the present application in place of the more conventionally used term control code and the term “control code” will be used to refer to the encoded control character. For example, the GbE control code that typically is an 8-bit value will be referred to as a control character and the encoded GbE control character that typically is a 4-bit value will be referred to as a control code.

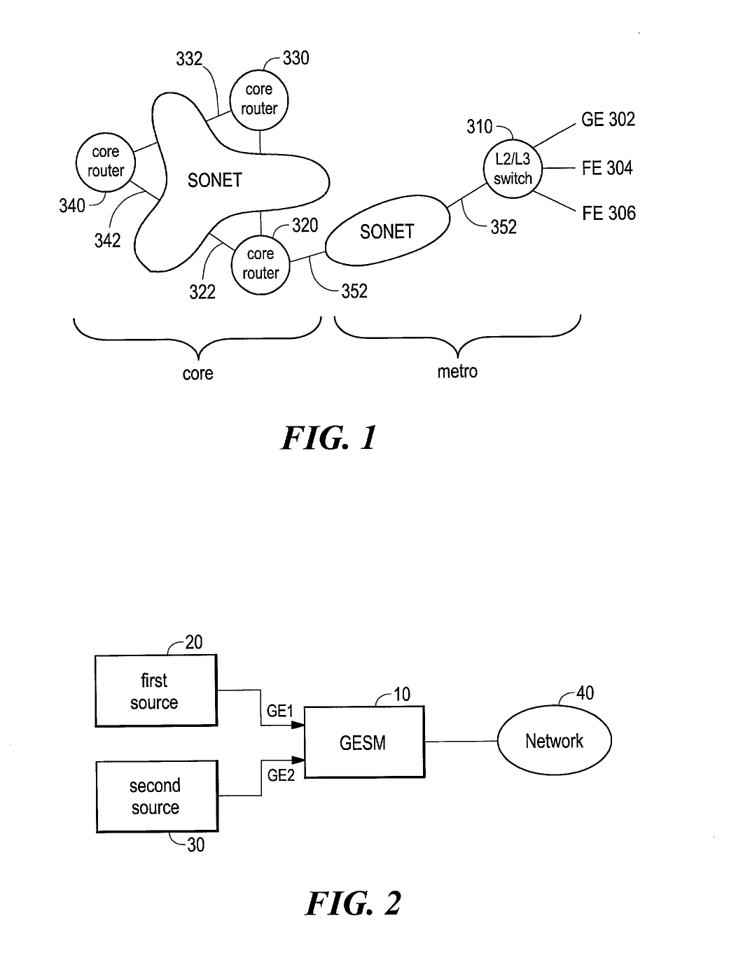

As illustrated in FIG. 1, GbE and FE customer interfaces (GE 302, FE 304, and FE 306) are aggregated at an L2/L3 switch 310 at the network edge. The efficient encoding method according to an embodiment of the present invention, carries the encoded signal to the nearest GbE core router 320 over the SONET/SDH based MAN. GbE signals 322, 332, 342 and 352 encoded by this encoding method may also be transmitted between core routers 330 and 340 over long-haul SONET/SDH based networks. By this encoding method, the data-carrying capacity necessary for the GbE traffic may be minimized so that the signals are efficiently and transparently transported over the networks.

In another embodiment of the present invention, a platform is illustrated in FIG. 2 which includes a 2-port Gigabit Ethernet Service Module (GESM) 10 for receiving two signals, GE1 and GE2, from first and second sources 20 and 30 respectively. The GESM 10 time multiplexes the GE1 and GE2 signals onto an output signal transported through the optical network 40. In particular, the GE1 and GE2 signals may be GbE signals having a signaling rate of 1.25 Gbps each that are desired to be transmitted using a generic framing procedure (GFP) or packet over SONET (POS) for encapsulating data over SONET/SDH using an output signal having an OC-48 rate (2.488 Gbps). Because the combined rate of the GE1 and GE2 signals (2.5 Gbps) exceeds the data rate of 2.488 Gbps for OC-48, the GE1 and GE2 signals must be modified to successfully transmit the information across the network. In one known technique for addressing this problem, the GESM 10 decodes the GE1 and GE2 signals so that they are stripped of run-length coding overhead information. As a result, the combined rate for the modified GE1 and GE2 signals is less than the maximum rate of the OC-48 output signal, and therefore may be transmitted across the network.

Signals include both data information and control information. Codes unused for data information are used to convey the control information. In order to provide transparent service, the combined data rate of the GbE signals must be reduced to be less than the maximum bandwidth of the output signal while maintaining the control overhead information. It is also desirable to provide transparent service for a single signal on an output signal which maximizes the utilization on the available bandwidth. Accordingly, coding schemes are provided in the embodiments of the present invention for encoding the transmitted signals so that they may be efficiently and transparently transported within the available bandwidth of the output signal to the network without sacrificing any control information.

In one example of a coding scheme, one bit may be used to signal whether a decoded word of the input signal includes data or control information. In particular, when the decoded word has 8-bits and 1-bit indicates whether the decoded word is a data word or a control character, 512 different words (2⁹=512 words) may be represented by the nine bits. Typically, only 256 data words and a lesser amount of control characters (for example, the use of 12 GbE control characters is typical) are needed to be represented by the 512 available words. As a result, over 200 words are unused which wastes the utilization of bandwidth on bits for words that convey no information.

The coding scheme according to one embodiment of the present invention encodes information groups, or a group of words to an encoded information stream, or encoded bit stream. The group of words may include only data words, only control characters or a combination of control characters and data words. The encoding depends upon whether each information group includes control characters, data words or a combination. If only data words are determined to be present in each information group, a data indicator, such as setting a bit to “0”, is generated and then the encoded information stream is created to include the data indicator followed by the data words. If at least one control character is present within the information group, a control code map, such as a fixed-size block of bits, is generated for representing the presence of at least one control character and the positions of the control codes within the encoded information stream. For example, the control code map may be generated by setting the first bit to “1”, setting positions corresponding to data words to “0” and positions corresponding to control characters to “1”. As a result, the data rate necessary for transporting the group of words over the communications link is reduced while all of the control information is maintained.

The number of word groups, n, the number of bits within each word, B, and the number of control codes, C, are known, fixed values. Accordingly, the amount of information to be transported, A, may be determined according to the following relationship:

A=2^{B}+C (1)

When transmitting the word groups, the minimum amount of bits, Nₙ, necessary for transporting all of the word groups over the communications link is related by the following equation:

Nₙ=[log₂ Aⁿ]=[n log₂ A] (2)

The minimum bit rate, Rₙ, needed for transporting the encoded bit stream over the communications link is related by the equation:

$${R}_{n} = \frac{{N}_{n}}{n \cdot B} = \frac{⌈ n {log}_{2} A ⌉}{n \cdot B} ( Gbps ) \qquad ( 3 )$$

In one specific example for this general relationship, when 8-bit words of GbE signals having 12 control codes are transmitted (B=8 and C=12), the amount of information to be transported over the communications link, A, is 268 bits. Therefore, the minimum number of bits in the encoded bit stream and the word groups, Nₙ and n, are related by:

Nₙ=[n log₂ 268]=[8.066n]. (4)

Based on Eq. (3), the bit rate and the minimum bits needed in the encoded bit stream, Rₙ and Nₙ, in this example are related by:

$${R}_{n} = \frac{{N}_{n}}{8 n} ( Gbps ) \qquad ( 5 )$$

Table 1 illustrates relationships between the number of bits and the bit rate of the encoded bit stream for a series of word groups in this example:

TABLE 1

| n | Nₙ | Rₙ |
|---|---|---|
| 1 | 9 | 1.125 |
| 2 | 17 | 1.0625 |
| 3 | 25 | 1.04167 |
| 4 | 33 | 1.03125 |
| 5 | 41 | 1.0250 |

In this example, the minimum number of bits in the n-word encoded bit stream can be approximated as:

Nₙ≈8.066n+1. (6)

Also, the minimum bit rate needed for transporting the encoded bit stream over the communications link can be approximated as:

$${R}_{n} \approx \frac{8.066 n + 1}{8 n} \cdot ( Gbps ) \qquad ( 7 )$$

Therefore, as the number of word groups gets sufficiently large (n→∞) the bit rate approaches a limit of Rₙ→8.066/8≈1.0082 (Gbps). This means that the STS-21 rate of 1.04 Gbps is the minimum bit rate that can be used for transporting payload because the STS-20 rate of 990.72 Mbps is less than the 1.0082 Gbps minimum GbE bit rate.

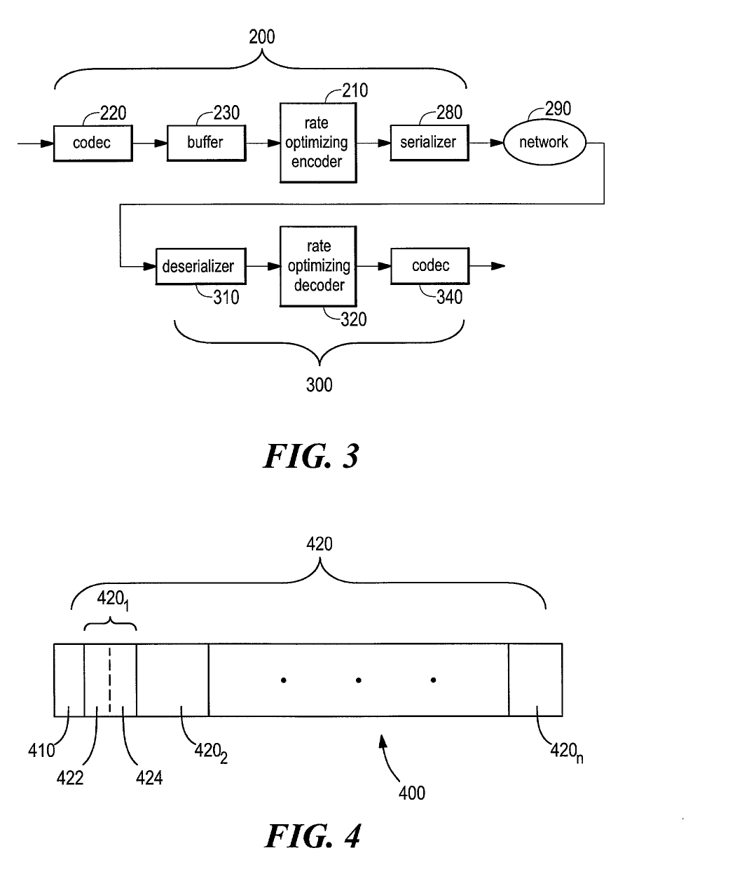

FIG. 3 illustrates an embodiment of the present invention including a transmitting portion 200, a network 290, and a receiving portion 300. At the transmitting portion 200, a rate optimizing encoder 210 receives a stream of GbE information groups, or word groups, which may contain data or control characters, to be transmitted to the network 290 via a serializer 280. The word groups are received by the rate optimizing encoder 210 via a codec 220 and a buffer 230 after the buffer 230 determines that a complete set of word group has been received. The rate optimizing encoder 210 detects if the word group contains any control characters. If any control characters are detected within the word group, the rate optimizing encoder 210 reads a control code from an internal encode map look up table (LUT, not shown) corresponding to each of the detected control characters contained in the word group. The control codes have fewer bits than the control characters contained in the word group. Optimally, the control codes include as few bits as possible to uniquely map each of the control characters. For instance, if 12 control characters are used, four bits are the minimum number of bits required to uniquely map each of these to control codes. In another example, if eight control characters are used, three bits are required to uniquely map each of these to control codes.

The rate optimizing encoder 210 generates a data indicator, or an indicator bit, when there are no control characters detected in the word group. For instance, the indicator bit may be set to a first logical level (the bit may be set to “0” for example) for indicating that only data will follow. When there are no control characters present, the indicator bit and the word group containing all data is sent to the serializer 280. Thereafter, the serializer 280 generates the encoded information stream 400 as illustrated in FIG. 4, which includes the indicator bit 410 followed by the data sections 420, to be sent to the network 290. When there are no control characters present in the word group, the data is contained within equally divided bit sections 420₁, 420₂, . . . 420ₙ of the encoded information stream 400. When at least one control character is present in the word group, the first bit section 420₁ is divided into two sub-sections 422 and 424 for storing a control code map and a control code as will be described in more detail. In one example of segmenting the encoded information stream when four 8-bit words are transmitted, the data portion of the encoded information stream 400 is divided into a first bit for the indicator bit followed by four 8-bit sections for the data.

The rate optimizing encoder 210 also generates the control code map when at least one control character is detected in the word group. One bit of the control code map is set to a second logical level opposite to the first logical level of the indicator bit (in this example, the first bit is set to “1”) for indicating that at least one control character is present. The control code map also includes a field of bits for representing the sequential position(s) within the word group that contain control character(s). The number of bits in the bit field corresponds to the number of words, n, in the word group. For instance, if there are four words in the word group, n=4, then the number of bits used in the bit field is four. Thereby, the first bit in this bit field represents that the first word contains data when set to a first logical level (such as “1”) or that the first word contains a control character when set to a second logical level (such as “0”) opposite to the first logical level of the first bit. The setting for the three remaining bits also follows this convention.

When at least one control character is present within the word group, the data indicator, the control code map, the control codes, and any data present are then sent to the serializer 280 which generates the encoded information stream 400 to be sent to the network 290. The serializer 280 includes logic for generating the positioning of the control code map, control codes, and data, if present, within the bit sections 420₁, . . . 420ₙ of the encoded information stream 400. In one example of the logic, the encoded information stream 400 may include the control code map in the sub-section 422 and one of the control codes in the sub-section 424 of the first bit section 420₁. The following bit sections 420₂, . . . 420ₙ may include either data or control codes. The control codes and any present data are positioned to correspond with the positions indicated by the control code map. It is appreciated that the data indicator 410, sub-sections 422 and 424 and sections 420₁, 420₂, 420₃, and 420₄ may be arranged in many other predetermined orders within the encoded information stream 400 and it is not necessary to have these fields be physically contiguous within the encoded information stream 400 as long as the fields can be found according to predetermined logic.

Because the control codes are advantageously designed to have fewer bits than the bits contained in the word groups, the control codes may include dummy bits in unused fields. For instance, if the encoded information stream 400 is divided into 8-bit sections and the control codes are 4-bits, then the first four bits in a bit section having control codes may include “0000” as dummy bits. As a result, the encoded information stream 400 transports all of the control information and data to the network 290 at a lower data rate than that of the originally transmitted word groups.

At the receiving end 300, a deserializer 310 receives the encoded information stream 400 from the network 290. The deserializer 310 extracts the indicator bit 410 and a plurality of information groups, or word groups, from the encoded information stream 400. The number of word groups corresponds to the number of word groups originally transmitted from the transmitting portion 200. The extracted word groups are sent to a rate optimizing decoder 320. The rate optimizing decoder 320 decodes the received word groups based on the data indicator 410. Preferably, the data indicator 410 is the first bit received at the beginning of the encoded information stream 400. If the indicator bit 410 is set (a low logical level, “0”, for example), the received word groups include only data and are directly output from the rate optimizing decoder 320 to a codec 340 for generating word groups in their originally transmitted form.

However, if the data indicator 410 is not set (at a high logical level, “1”, for example), the encoded information stream 400 includes at least one control code that must be decoded. In such cases, the rate optimizing decoder 320 reads the control code map and the control code from the first bit section 420₁ and determines which, if any, of the remaining bit sections 420₂, . . . 420ₙ contain control codes based on the set bits in the control code map. For each of the bit sections that are determined to contain control codes, the rate optimizing decoder 320 refers to an internal decode LUT (not shown) to decode the control codes into the control characters as originally transmitted.

The decode map LUT contains similar information as contained in the encode map LUT of the rate optimizing encoder 210 but the decode map LUT uses this information to decode the control codes back to their original form. If the control code map indicates that the corresponding section contains data, no decode processing is performed. Once the rate optimizing decoder 320 determines that all of the bit sections have been received, the data and control characters may be positioned in their proper order based on the set bits in the control code map. The codec 340 receives the properly ordered sections from the rate optimizing decoder 320 and generates the original 10-bit encoded GbE output signal.

The coding scheme according to the embodiments of the present invention allows information to be transparently transported across the network at a reduced data carrying capacity by encoding the information to the encoded information stream before being transported across the network. After the encoded information stream has been received from the network, the encoded information stream may then be decoded back to the original information according to the predetermined known logic.

In one embodiment of the invention, the coding scheme is particularly applicable for transmitting GbE data and control codes using an STS-21 signal. In a specific example of this embodiment, four 10-bit words are respectively decoded by the codec 220 via buffers 230 into four 8-bit words. The four 8-bit words are then input to the rate optimizing encoder 210. If none of the four 8-bit output words contain a control character, the rate optimizing encoder 210 sets the indicator bit to “0”. Then, the rate optimizing encoder 210 outputs the indicator bit and the four 8-bit data words to the serializer 280. Thereafter, the serializer 280 generates a 33-bit encoded information stream 400, which represents all of the information contained in the originally transmitted four 10-bit words. For example, the encoded information stream 400 may be represented by 0-D1-D2-D3-D4 where “0” is the indicator bit followed by D1, D2, D3, and D4 each representing 8-bits of data.

If at least one of the four 8-bit words contains a control character, the rate optimizing encoder 210 encodes each 8-bit control character into a 4-bit control code. The data indicator 410 and the control code map are generated by the rate optimizing encoder 210 such that a first bit is set to “1” as the data indicator 410 for indicating that at least one control character is present followed by a 4-bit field for representing the sequential positions of control characters and data for the four words. Table 2 illustrates the 15 possible cases for the sequential positioning of data and control characters for the four words. In Table 2, D represents the position for a word containing data and K represents the position for a word containing control characters. Thereby, DDKD represents that words 1, 2, and 4 contain data and word 3 contains a control character.

TABLE 2

| Data-Control | 4-bit Code |
|---|---|
| Combinations | Map |
| DDDK | 0001 |
| DDKD | 0010 |
| DDKK | 0011 |
| DKDD | 0100 |
| DKDK | 0101 |
| DKKD | 0110 |
| DKKK | 0111 |
| KDDD | 1000 |
| KDDK | 1001 |
| KDKD | 1010 |
| KDKK | 1011 |
| KKDD | 1100 |
| KKDK | 1101 |
| KKKD | 1110 |
| KKKK | 1111 |

The encoder 210 encodes the GbE control characters into the 4-bit control codes through the encode map LUT. Table 3 illustrates one example for encoding 12 GbE control characters to 4-bit control codes. For the four unused 4-bit codes, user-defined control codes may also be supported, if desired, for sending undefined control characters for special purposes. In Table 3, the notation XX.Y represents the decimal value of the first 5 bits by XX and the decimal value of the last 3 bits by Y.

TABLE 3

| GbE Control | |
|---|---|
| Characters | 4-bit Codes |
| K28.0 | 0000 |
| K28.1 | 0001 |
| K28.2 | 0010 |
| K28.3 | 0011 |
| K28.4 | 0100 |
| K28.5 | 0101 |
| K28.6 | 0110 |
| K28.7 | 0111 |
| K23.7 | 1000 |
| K27.7 | 1001 |
| K29.7 | 1010 |
| K30.7 | 1011 |
| User defined | 1100 |
| User defined | 1101 |
| User defined | 1110 |
| User defined | 1111 |

Next, the control code map and the control codes are sent to the serializer 280 for generating the 33-bit encoded information stream 400. When control codes are present, the sub-sections 422 and 424 are used for the control code map and one of the control codes. If a control code is present in the first word, this control code is placed within the sub-section 424, and each remaining bit section 420₂, 420₃, and 420₄ includes control codes and/or data. However, if the first input word is a data word, then one of the control codes must be selected for placement within the sub-section 424 and the data word must be placed elsewhere. This placement can be done in different ways including shifting and swapping. In shifting logic, the first occurring control code is placed within sub-section 424 and control codes and/or data are shifted as necessary to fill the three remaining bit sections 420₂, 420₃, and 420₄. For example, for a pattern of D₁D₂K₁D₃, K₁ in the word 3 position is placed in the sub-section 424 and D₁D₂D₃ follows in bit sections 420₂, 420₃, and 420₄ respectively so the encoded information stream 400 is represented as 10010K₁-D₁-D₂-D₃.

In swapping logic, the first occurring control code is swapped with the data of the first occurring word and the non-swapped data and/or control codes remain in the originally transmitted positions. For example, for a pattern of D₁D₂K₁D₃, the first occurring control code K₁ in the word 3 position is swapped with D₁. K₁ is placed in the sub-section 424 and D₂D₁D₃ follows in bit sections 420₂, 420₃, and 420₄ so that the encoded information stream is represented as 10010K₁-D₂-D₁-D₃. It should be appreciated that other logic may be used for placing one of the control codes after the control code map within the sub-section 424.

With this coding scheme, four consecutive 10-bit input words may be encoded to the 33-bit encoded information stream 400 for transport over the network 250. Table 4 illustrates four examples of encoding four 10-bit input words to the 33-bit encoded information stream using shifting logic. For GbE data having a 1.25 Gbps input bit rate, a reduction to a 1.03 Gbps output bit rate may be realized with this coding scheme. After this reduction, the encoded data stream 400 may be carried by an STS-1-21 signal with a payload capacity of 1.04 Gbps (21×49.536 Mbps). As a result, data may be carried transparently and efficiently over a communications link having a reduced data-carrying capacity.

TABLE 4

| Four 10-bit Input | 1st | First 8- | Second 8- | Third 8- | Fourth 8- |
|---|---|---|---|---|---|
| Words | Bit | bit Section | bit Section | bit Section | bit Section |
| D11.3 D24.2 D18.5 | 0 | 11.3 | 24.2 | 18.5 | 4.7 |
| D4.7 | | | | | |
| D11.3 K28.5 K27.7 | 1 | 0110 0101 | 11.3 | 0000 1001 | 4.7 |
| D4.7 | | | | | |
| D11.3 D4.7 K29.7 | 1 | 0011 1010 | 11.3 | 4.7 | 0000 0101 |
| K28.5 | | | | | |
| K29.7 K28.7 D23.5 | 1 | 1100 1010 | 0000 0111 | 23.5 | 18.1 |
| D18.1 | | | | | |

At the receiving portion 300 in this example, the 33-bit encoded information stream 400 received from the network 290 is decoded back to its original form of four 10-bit words. The deserializer 310 receives the encoded information stream and extracts the data indicator 410 (preferably the first bit) and the four 8-bit sections therefrom. The extracted data indicator 410 and the four 8-bit sections 420₁, 420₂, 420₃, and 420₄ are then sent to the rate optimizing decoder 320 for decoding. If the data indicator is set (a “0” bit), the four 8-bit data sections 420₁, 420₂, 420₃, and 420₄ are input to the codec 340. Thereby, four 10-bit words are output from the codec 340 in the same form as originally transmitted.

If the data indicator 410 is not set (first bit is “1”), the rate optimizing decoder 320 determines which of the sections 420ₙ in the encoded information stream 400 contain control codes by analyzing the control code map in sub-section 422. For example, if the first five bits of the encoded information stream are “11010”, the data indicator 410 is set and control characters were present in the first and third originally transmitted word group. Therefore, in the encoded information stream 400, the sub-section 424 and the third section 420₃ contain control codes and the second and fourth sections 420₂ and 420₄ contain data. In general, the rate optimizing decoder 320 decodes the first control code in the sub-section 424 of the encoded information stream 400, and any of the other 8-bit sections 420ₙ in the encoded information stream 400 containing control codes, back to control characters by referring to the decode map LUT. When the rate optimizing decoder 320 receives all of the encoded information stream 400, the 8-bits of data and/or control characters are arranged in their proper order based on the control code map in the sub-section field 424. The four 8-bit words are then output to the codec 340 so that the four 10-bit words are output therefrom in the same form as originally transmitted.

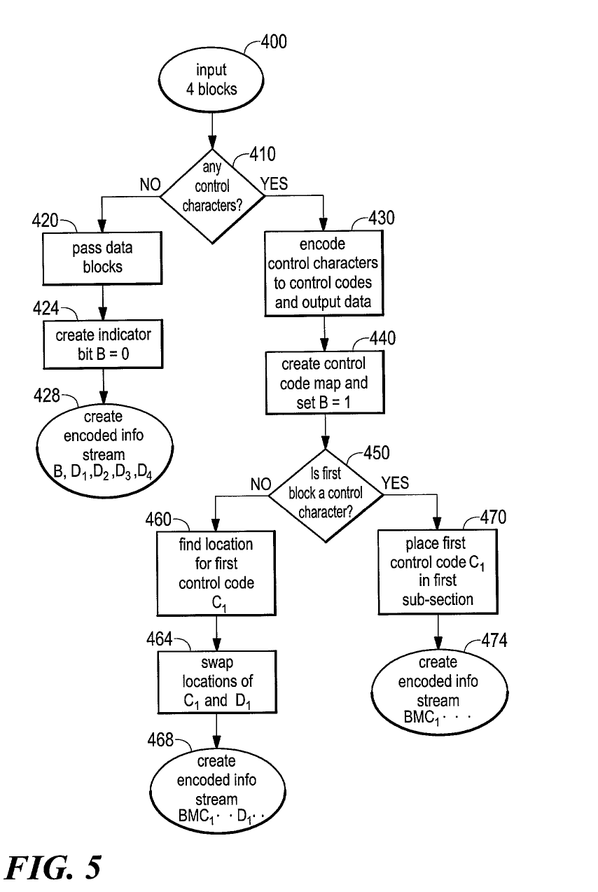

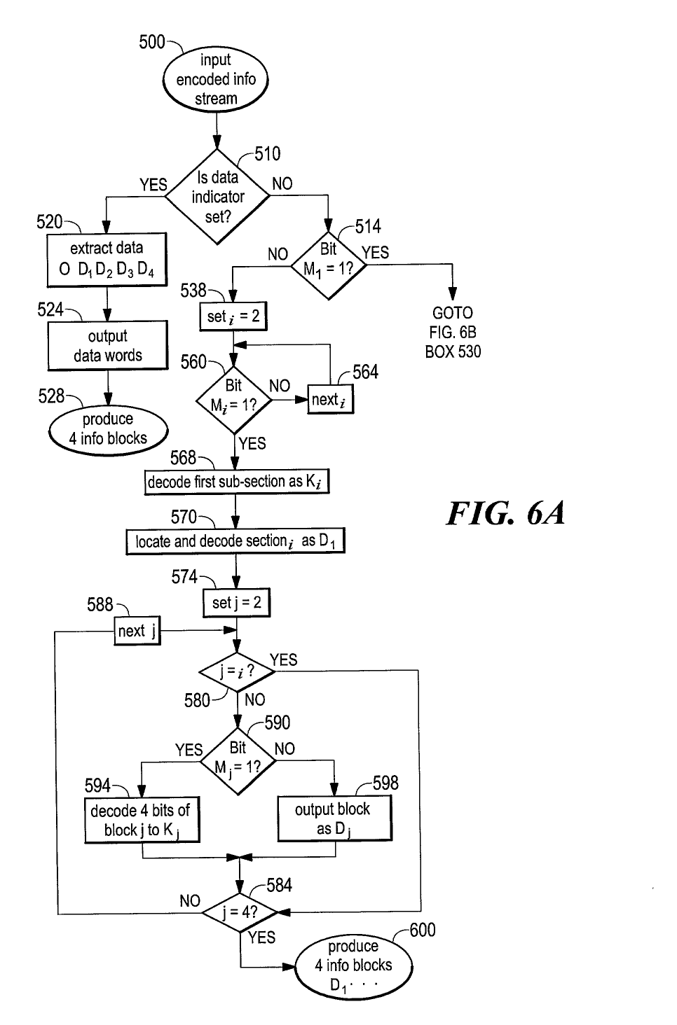

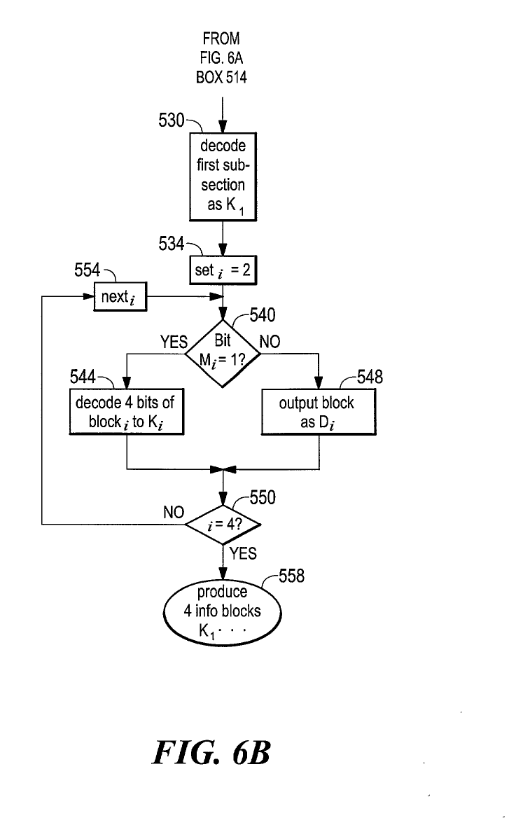

FIGS. 5 and 6 are flowcharts illustrating encoding and decoding algorithms for transmitting GbE data and control characters in an embodiment of the present invention. The swapping technique described above is used in the encoding algorithm of FIG. 5, and four 10-bit groups are input to the transmitting portion 200 of a communications link at step 400. A determination is made at step 410 as to whether any control characters are present within any of the four groups. If no control characters are present, then only data is present and the groups are encoded to 8-bits of data words (D1, D2, D3, and D4) at step 420 and an indicator bit is set (B=0) at step 424. Next, the 33-bit encoded information stream is created at step 428. The 33-bit encoded information stream may be represented by 0-D1-D2-D3-D4, where 0 is the indicator bit followed by the four 8-bit data sections.

If at least one control character is present within the group, the control character(s) are encoded to 4-bit control code(s), and the control code(s) and data word(s), if present, are output at step 430. Then, the data indicator 410 is not set (B=1) and the control code map M is created at step 440. The control code map M includes four bits in the sub-section 422 (M1, M2, M3, and M4) for indicating whether the corresponding bit section (420₁, 420₂, 420₃, or 420₄) contains either a control code (by setting the bit to “1”) or a data word (by setting the bit to “0”). A determination is made at step 450 as to whether the first word contains a control character by use of the control code map M. If the first word contains a control character, the first 4-bit control code C1 is placed in the sub-section 424 (bits 6-9) at step 470. In the remaining three 8-bit sections, the control code(s) and/or data are placed in the respective section and the 33-bit encoded information stream represented by BMC1 . . . is created at step 474. The 4-bit control codes are preceded by a “0000” padding so that they fit within the 8-bit sections 420ₙ.

If the first word is determined to contain data at step 450, the position of the first data word D1 is swapped with the first control code C1 at step 464. As a result, the first control code C1 is placed in the sub-section 424 and the 8-bit data word takes the place of the first control code C1 in its corresponding section (420₂, 420₃, or 420₄). Thereafter, the 33-bit encoded information stream 400 is created at step 468 as is represented by BMC1 . . . D1 . . . , where D1 and C1 swap locations and the other control code(s) and/or data word(s) remain in their original locations.

A decoding algorithm for an embodiment of the present invention is next described with reference to FIG. 6. The 33-bit encoded information stream 400 is received from the communications link and input to the receiving portion 300 at step 500. At step 510, a determination is made as to whether the data indicator 410 is set (the first bit is “0”). If the data indicator 410 is set, only data will be present within the encoded information stream 400. The encoded information stream 400 is grouped into blocks at step 520 by extracting the first bit (“0”) and the four 8-bit sections as represented by 0D1D2D3D4. The four 8-bit sections are passed through the rate optimizing decoder 320 and output to the codec 340 at step 524 and four 10-bit data blocks are produced by the codec 340 at step 528.

If it is determined at step 510 that the data indicator is not set (the first bit is “1”), then the control code map in sub-section 422 (bits M1, M2, M3 and M4) is analyzed at step 514 because at least one control code must be present in the encoded information stream 400. If M1=1, the encoded control code in the sub-section 424 contains the first control code in its proper position. Therefore, the control code C1 in the sub-section 424 is decoded to the control character K₁ at step 530. Next, the remaining three sections 420₂, 420₃, and 420₄ of the encoded information stream are sequentially decoded based on the control code map bits M2, M3, and M4 of the sub-section 422.

Control code map bit M2 is analyzed first by setting a counter (i=2) at step 534 in order to determine at step 540 whether the second 8-bit section 420₂ of the encoded information stream contains a control code or 8-bits of data. If M2=1, the section 420₂ contains a control code and the last four bits of this section are decoded back to its originally transmitted control character Ki at step 544. If M2=0, the section 420₂ contains 8-bits of data and passes through and output from the rate optimizing decoder 320 at step 548. These steps are repeated for the third and fourth sections 420₃ and 420₄ until all of the sections (420₂, 420₃, and 420₄) have been analyzed. If the last counter value (i=4) has not been reached, the counter i is incremented at step 554. Finally, the four 10-bit blocks of control character(s) and/or data are produced at step 558 as represented by K1-.-.-. where the control character K1 appears first followed by other control characters and/or data.

If it is determined that the first originally transmitted block contains data because M1=0 at step 514, the original location for the first appearing control code must be determined by analyzing the next three bits of sub-section 422 (M2, M3, and M4). This is accomplished by setting a counter (i=2) at step 538 and determining whether M2=1. If M2=1 at step 560, then the second word group contained the original control character and sub-section 424 contains the control code which must be decoded to control character K1 at step 568. If M2=0 at step 560, then the counter is incremented at step 564 and the next bit (M3) is analyzed at step 560. These steps 560 and 564 are repeated for M4, if necessary, until the first one of M2, M3, and M4 is found to equal “1”.

After finding the location (by the value of counter i) for the first appearing control code, the section for the 8-bits of data that should be appearing in the first block is located based on the counter value i. The i-th section (420ᵢ) of the encoded information stream 400 is extracted and decoded at step 570 so that first data word D1 is obtained. Next, the remaining two sections (which are not swapped) are decoded. This is accomplished by setting a counter (j=2) at step 574 and analyzing whether this counter j is equal to the location of the swapped control code (j=i) at step 580. If j≠i, then it is determined whether the corresponding section 420ⱼ contains a control code or data word at step 590. If Mj=1, the last four bits of the section 420ⱼ are decoded back to the corresponding originally transmitted control character Kj at step 594. If Mj=0, the section 420ⱼ is passed through and output from the rate optimizing decoder 320 at step 598. These steps are repeated for the third and fourth sections 420₃ and 420₄. If the last counter value (j=4) has not been reached, the counter j is incremented at step 588. Finally, the four 10-bit blocks of control character(s) and/or data are produced at step 600 as represented by D1-.-.-. where the data D1 appears first followed by control character(s) and possibly more data.

It will be apparent to those skilled in the art that other modifications to and variations of the above-described techniques are possible without departing from the inventive concepts disclosed herein. Accordingly, the invention should be viewed as limited solely by the scope and spirit of the appended claims.

What is claimed is:

1. A method for transporting multi-word information groups containing data words and control characters over a communications link, comprising the steps of:
(a) determining whether each of said information group includes control characters;
(b) for each information group that does not include control characters, setting a data indicator and combining said data indicator with the data words to generate an encoded information stream including said data indicator and the data words;
(c) for each information group that includes one or more control characters, generating an encoded information stream by the steps of
(i) encoding the control characters to control codes,
(ii) placing said data indicator to an unset condition,
(iii) generating a control code map representing placement positions for said control characters in said information group, and
(iv) combining said data indicator, said control code map, said control codes, and any data words to generate said encoded information stream.

2. A method according to claim 1, wherein a data-carrying capacity for the communications link is less than the signaling rate of said information group.

3. A method according to claim 1, wherein each of said information groups comprises a predetermined number of words and each of said words comprise a predetermined number of bits.

4. A method according to claim 1, wherein the number of bits in the encoded information stream is less than the number of bits in said information group.

5. A method according to claim 1, wherein said step (b) further comprises the step of setting said data indicator as a first bit to a first logical level to indicate the presence of only data in said encoded information stream.

6. A method according to claim 5, wherein said step (c) further comprises the step of placing said first bit to a second logical level opposite to said first logical level as said data indicator to indicate the presence of one or more control characters in said encoded information stream and setting mapping bits, which correspond in number to the number groups in said information group, to represent the presence or absence of said control characters in the corresponding group for generating said control code map.

7. A method according to claim 1, further comprising the steps of:
(d) receiving the encoded information stream from the communications link;
(e) determining whether the encoded information stream comprises said data indicator being set;
(f) extracting the data words from the encoded information stream to generate said information group when said data indicator is determined as being set;
(g) reading said control code map and extracting said control codes and any data words present in said encoded information stream based on said control code map when said data indicator is determined as being not set; and
(h) decoding said control codes to said control characters and generating said information group to include said control characters and any data words when said data indicator is determined as being not set.

8. A method for transporting multi-word information groups containing data words and control characters over a communications link, comprising the steps of:
(a) encoding each of said information groups to an encoded information stream including a set data indicator followed by data words when said information group does not include control characters; and
(b) encoding control characters to control codes, generating a control code map and combining an unset data indicator, said control code map, said control codes, and any data words when one or more control characters are included in said information group.

9. A method according to claim 8, wherein said step (a) further comprises the step of configuring the data words in the same order as in said information group when said information group does not include control characters.

10. A method according to claim 8, wherein said step (b) further comprises the step of generating said control code map to represent that said information group includes control characters and to indicate sequential positions of said control characters within said information group.

11. A method according to claim 10, wherein said step (b) further comprises the steps of setting a first bit to a first logical level as said set data indicator when said information group does not include control characters, and setting said first bit to a second logical level opposite to said first logical level when said information group includes one or more control characters.

12. A method according to claim 11, further comprising the step of generating the encoded information stream to include said first bit being followed by a plurality of sections, the number of said sections corresponding to the number of words in said information group.

13. A method according to claim 12, wherein said step (a) further comprises the step of placing said set data indicator in said first bit and said data words in said sections.

14. A method according to claim 12, wherein said step (b) further comprises the step of placing said unset data indicator in said first bit, said control code map and one of said control codes in the first of said sections, and the remaining of said control codes and any data words in subsequent ones of said sections.

15. A method according to claim 13, wherein said step (b) further comprises the step of sequentially placing the remaining of said control codes and any data words in subsequent ones of said sections in the same order as the corresponding words are present in said information group.

16. A method according to claim 13, wherein said step (b) further comprises the steps of swapping the positions for the first occurring one of said control codes with the first occurring one of said data words and then sequentially configuring said sections to include said control code map and the re-ordered one of said control codes in the first of said sections followed by remaining ones of said control codes and any data words in subsequent ones of said sections.

17. A method according to claim 8, wherein said control code map comprises a predetermined number of bits.

18. A method according to claim 17, wherein said predetermined number of bits is equal to one more than the number of words in said information group.
